(19) United States
(12) Patent Application Publication
(10) Pub. No.: US 2001/0024629 A1
(43) Pub. Date: Sep. 27, 2001

(54) Reformer of layered structure

(76) Inventors: Stefan Brauchle, Heroldstatt (DE); Tobias Remsch, Wurzach (DE); Dietmar Heil, Schwendi (DE); Wolfgang Schmid, Sindelfingen (DE)

Correspondence Address: EVENSON, McKEOWN, EDWARDS & LENAHAN, P.L.L.C., 1200 G Street, N.W., Suite 700, Washington, DC, 20005, US

(21) Appl. No.: 09/759,251

(22) Filed: Jan. 16, 2001

(30) Foreign Application Priority Data
Jan. 13, 2000 (DE) 100 01 064.4

(51) Int. Cl. F28D 9/00; B01J 8/00

(52) U.S. Cl. 422/198; 422/188; 422/190; 422/193

(57) ABSTRACT

A reforming reactor has a layered structure with an alternating sequence of reforming layers filled with a reforming catalyst material for an endothermic reforming reaction, and heating layers which adjoin the reforming layers via thermally conductive partition and contain a heating-space catalyst material for an exothermic reaction. The volume of the respective reforming layers is greater than that of the respective heating-space layers; and the heating-space catalyst material is introduced into the corresponding heating layer as a wall coating.

### BACKGROUND AND SUMMARY OF THE INVENTION

This application claims the priority of German patent document 100 01 064.4, filed Jan. 13, 2000, the disclosure of which is expressly incorporated by reference herein.

The invention relates to a reforming reactor having a layered structure.

Reformers of this type are used, for example, for generating hydrogen in a fuel cell vehicle or in stationary installations by endothermic steam reforming of a hydrocarbon or hydrocarbon derivative, such as methanol. For this purpose, the mixture of substances which is to be converted is introduced into the one or more reforming layers which alternate with heating layers, in a corresponding layer sequence. When the reactor is operating, an exothermic reaction is carried out in the respective heating layers, in order to provide the heat which is required for the endothermic reforming reaction in the reforming layer(s). The heat transfer from each heating layer to one or both adjacent reforming layers takes place via a corresponding partition which has good thermal conductivity and is provided for fluid separation of the layers. The one or more heating layers contain a suitable heating-space catalyst material which catalyzes the intended exothermic reaction. Depending on the requirements, they may, for example, be designed as a catalytic burner which is fed a suitable fuel/oxygen mixture, or as a CO oxidation stage which is fed the reformate gas generated by the reforming reaction, in order to remove carbon monoxide contained therein by selective CO oxidation.

Numerous designs of reformers of this type are known, which vary particularly with regard to their plate structure, See, for example German patent document DE 197 27 589 A1; European patent documents EP 0 642 184 A2 and EP 0 691 701 A1; and U.S. Pat. Nos. 4,933,242, 5,015,444 and 5,180,561. As an alternative to the plate structure with planar layers, other layer designs are also possible, for example annular layers which are defined by tubes positioned coaxially inside one another.

In conventional reforming reactors of the above type, given the same layer area, the layer height of the reforming layers is usually selected to be equal to (or in some cases even slightly smaller than) that of the heating layers. That is, the volume of the respective reforming layers is at most approximately equal to that of the respective heating layers.

Particularly when used in fuel cell powered vehicles, the limited space available means that it is desirable for the structure of the reformer to be as compact as possible. On the other hand, the volume of the reforming layers must be kept large enough to enable a sufficient amount of reforming catalyst material to be introduced and the amount of unconverted hydrocarbon or hydrocarbon derivative starting material in the reformate gas generated to be kept at a low level.

One object of the invention is to provide a reformer of the type described above which (for a given, required reforming capacity) is as compact as possible, and with little outlay.

Another object of the invention is to provide a reference which is suitable in particular for generation of a hydrogen-rich gas for supplying fuel cells.

These and other objects and advantages are achieved by the reformer according to the invention, in which the layered structure is characteristically selected in such a way that the volume of the respective reforming layers is greater than that of the respective heating layers. At the same time, the heating-space catalyst material is introduced into the respective heating layer in space-saving form, as a wall coating.

Applying the heating-space catalyst material as a wall coating enables the heating-space layers to be designed with a relatively small volume, since there is no need for the catalyst material to occupy any of the volume of the heating layers (for example in the form of a bed of pellets). Consequently, substantially the entire volume of the respective heating layer is available for an associated flow of heating medium. For this reason alone a significantly lower layer height (i.e., layer width) can suffice compared to where the space is filled with heating-space catalyst material.

On the other hand, if a relatively large volume of the reforming layer(s) is used as mentioned previously, it is possible for a correspondingly large amount of reforming catalyst material to be introduced, for example in the form of a bed of pellets, so that a high reforming conversion capacity is provided. In addition, the relatively large reforming reaction space volume which is provided by the reforming layer(s) ensures that there is no excessive residual, unconverted starting material in the reformate gas.

In an advantageous embodiment of the invention, the volume of the respective reforming layers is selected to be at least twice as great as that of the respective heating layers. Accordingly, at least two thirds of the available volume of the reactor layer (comprising a sequence of one reforming layer and one heating layer) is available for carrying out the endothermic catalytic reforming reaction.

In another embodiment of the invention, the one or more heating layers function as a catalytic burner or as a CO oxidation stage; in the latter case, in addition to providing the heat for the reforming reaction, they also fulfil a gas cleaning function by removing carbon monoxide contained in the reformate gas from this gas by selective oxidation.

In a further embodiment of the invention, the respective heating layers are formed by the space inside a pair of corrugated profile plates which bear against one another. For this purpose, in an embodiment which is simple in terms of manufacturing technology, it is possible to use identical corrugated profile plates which are placed against one another with their corrugated profile longitudinal axes crossing one another. This at the same time provides the heating layer with a structured cross section of flow which, in addition, can be kept relatively small by selecting a correspondingly low corrugated profile height. This has the advantage of high flow velocities in the respective heating layer, leading to desired turbulent flows of the heating medium flowing through, and thus to highly efficient heat transfer. In each case two pairs of corrugated profile plates, which form heating layers, are arranged at a distance from one another leaving a gap so as to form a respective reforming layer, so that the width and therefore the volume of the reforming layer, as desired, is larger than that of the heating layer.

In another refinement of the reforming reactor according to the invention, support elements are introduced into each respective reforming layer, in order to support the plate walls, which delimit the reforming layer, with respect to one another. In this way, the overall reactor layers are strengthened against pressure differences which occur between individual layers, and the cross sections of flow of the individual layers are kept constant. In a further refinement of the invention, the same effect is achieved by forming the spacers at certain points on the delimiting plates of a respective reforming layer.

Other objects, advantages and novel features of the present invention will become apparent from the following detailed description of the invention when considered in conjunction with the accompanying drawings.

### BRIEF DESCRIPTION OF THE DRAWINGS

FIG. 1 shows a plan view of a reformer in plate structure;

FIG. 2 shows a sectional view taken along line II-II from FIG. 1;

FIG. 3 shows a sectional detail view taken along line III-III from FIG. 1;

FIG. 4 shows a sectional detail view along line IV-IV from FIG. 1; and

FIG. 5 shows a sectional detail view along line V-V from FIG. 1.

### DETAILED DESCRIPTION OF THE DRAWINGS

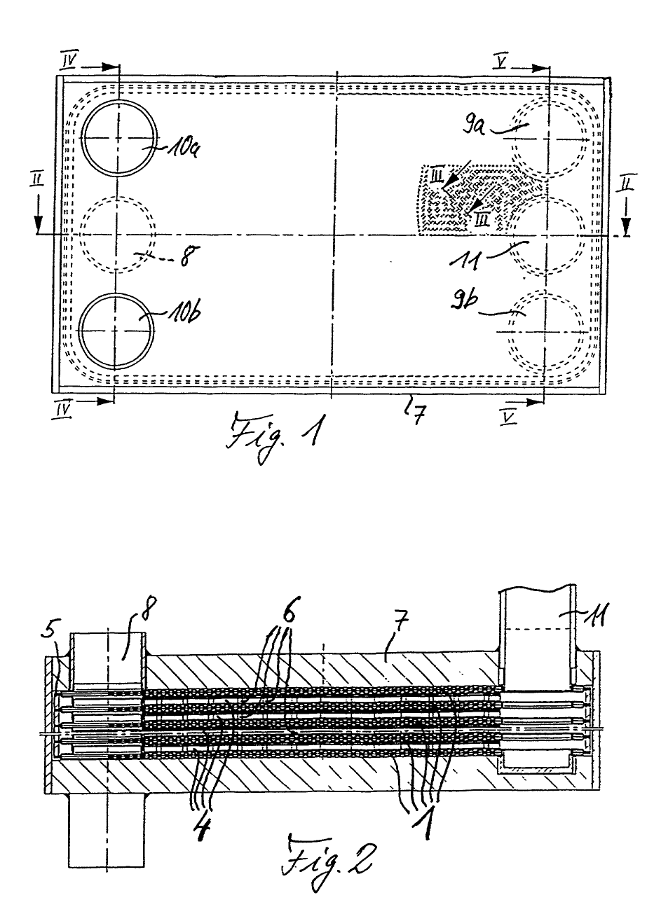

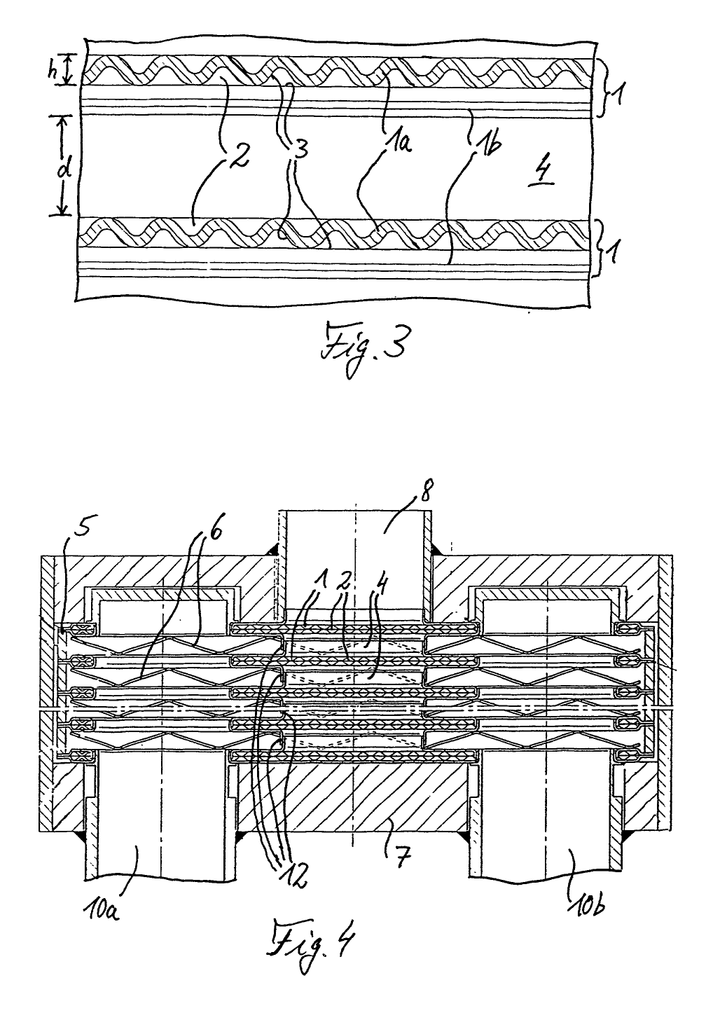

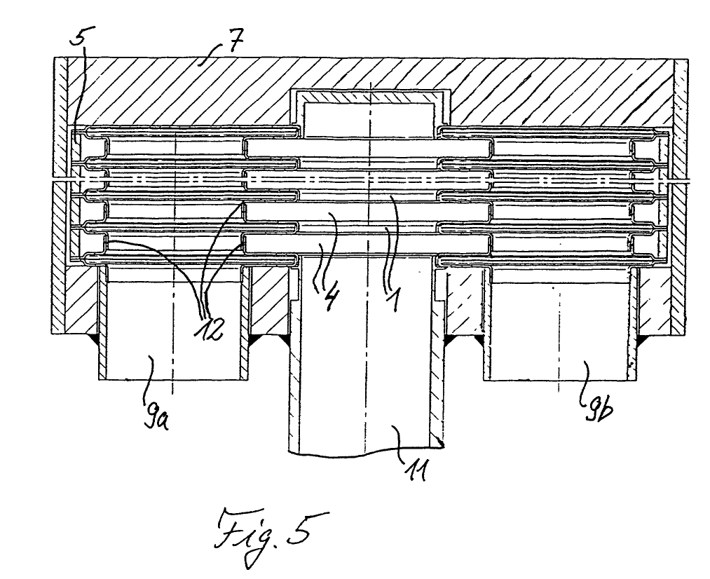

The reformer module, various views of which are shown in FIGS. 1 to 5, comprises a layered structure of planar plate elements which have been stacked on top of one another. It is suitable, for example, for generation of hydrogen for supplying fuel cells of a fuel cell powered vehicle, by endothermic steam reforming of methanol or another hydrocarbon or hydrocarbon derivative. As can be seen from the sectional illustrations in FIGS. 2 to 5, the layer stack comprises any selectable number of pairs 1 of corrugated profile plates, each pair comprising two corrugated profile plates 1a, 1b. The latter are placed on top of one another, with their corrugated structure oriented in such a way that the longitudinal axes of their respective corrugated structures cross one another at an angle of 90°, or alternatively at any other angle.

As a result, the two corrugated profile plates 1a, 1b of each pair 1 define an inner space 2 between them, with a corresponding crisscross corrugated structure of its delimiting walls on both sides in the direction of the stack; this space constitutes the respective heating layer. For this purpose, the two corrugated profile plates 1a, 1b of each pair 1 are provided, at least on their inner side, with a wall coating 3 of a heating-space catalyst material which catalyzes an exothermic (heat-generating) reaction which is to be carried out in the respective heating layer 2. Depending on the particular application, this exothermic reaction may, for example, be a catalytic combustion reaction of a fuel/oxygen mixture which is supplied or a selective oxidation of carbon monoxide which is contained in the reformate gas formed by the reforming reaction. Suitable fuels, for example the same starting material as that used for the reforming, and heating-space catalyst materials for catalyzing an exothermic reaction of this type are well known to the person skilled in the art.

In each case two pairs 1 of corrugated profile plates are arranged in a stack, leaving a space 4 between them, which provides the respective reforming layer in which the desired endothermic reforming reaction is carried out, and which for this purpose is filled with a suitable reforming catalyst material. The latter is not separately illustrated, for the sake of clarity, and is preferably in the form of a bed of catalyst pellets.

Therefore, in the reactor stack in each case one heating layer 2 and one reforming layer 4 alternate with one another. The heating layers 2 generate the heat which is required for carrying out the reforming reaction. For this purpose, it is transferred into the reforming layers 4 via the corrugated profile plates 1a, 1b. For this purpose also, the corrugated profile plates 1a, 1b consist of material with a good thermal conductivity, for example sheet metal. To maintain constant cross sections of flow of the individual layers 2, 4 in the event of any internal stresses in the corrugated profile plates 1a, 1b and pressure differences in the various layers 2, 4, in each case adjacent pairs 1 of corrugated profile plates are held at a distance from one another by edge-side holding elements 5, and moreover in each case a series of spacer webs 6 of angular corrugated structure are introduced into the reforming layers 4, as supporting elements, at suitable intervals, transversely with respect to the stacking direction.

As can be seen from FIGS. 1, 2, 4 and 5, the corrugated profile plates 1a, 1b are rectangular and the plate stack is situated in a correspondingly rectangular housing body 7 in which suitable connection structures are formed on the narrow sides. That is, distribution and collection channels are formed for the parallel supply and removal of the two media into and from the various heating layers 2, on the one hand, and the reforming layers 4 arranged alternately with the latter in the stack, on the other hand. Specifically, there are a heating-space inlet 8 for supplying the flow of substance which is to be converted in the heating layers 2, two heating-space outlets 9a, 9b for removing the associated product gas from the heating layers 2, two reforming inlets 10a, 10b for supplying the substance mixture which is to be converted in the reforming layers 4, and a reforming outlet for removing the reformate gas generated, in each case with their longitudinal axes parallel to the stacking direction. In the region of the various inlets and outlets 8 to 11, corresponding apertures are formed in the corrugated profile plates 1a, 1b, at the edge region of which apertures suitable closure sheets 12, which are angled off in cross section, are provided in such a manner that the fluid separation required on the one hand between the heating layers 2 and the reforming layer connections 10a, 10b, 11 and, on the other hand between the reforming layers 4 and the heating layer connections 8, 9a, 9b is ensured.

As can be seen in particular from FIGS. 2 to 4, the height h of the corrugated structure of the corrugated profile plates 1a, 1b is selected to be significantly less than the clear distance d between adjacent pairs 1 of corrugated profile plates. Consequently, the effective height (and therefore the volume) of the reforming layers 4 is greater by a multiple than the effective height (and volume or the free cross section of flow) of the heating layers 2. The dimensions are preferably selected in such a way that the volume of the reforming layers 4 which can be occupied by the reforming catalyst material is at least twice as great, and in the case illustrated, by way of example, approximately four times as great, as the volume of the heating layers 2 through which medium can flow.

This measure allows the reactor module to be of relatively compact structure to achieve a given, required reforming capacity. The relatively large overall volume of the reforming layers 4, which forms the reforming reaction space, allows a large amount of reforming catalyst material to be introduced, ensuring that there is no residue, or at most a slight, tolerated residue, of starting material which is to be reformed remaining in the reformate gas. On the other hand, the total volume of the heating layers 2, which functions as the heating space, is still sufficient to generate the heat required for the reforming. Due to the introduction of the heating-space catalyst material as a wall coating meaning that, despite the low height h of the heating layers 2, sufficient free cross section of flow still remains. The structured, relatively small cross section of flow of each heating-space layer 2 additionally has the desired effect of leading to high flow velocities and therefore to turbulent flows of the heating medium flowing through, which benefits the efficiency of heat transfer.

It will be understood that, in addition to the exemplary embodiment shown, further designs of the reformer according to the invention are possible. For example, instead of the corrugated profile plates with corrugated profile longitudinal axes which cross one another, it is also possible to provide in each case two corrugated profile plates with parallel corrugated profile longitudinal axes, in order to form an interposed heating layer. In the latter case, the corrugated profile plates are in contact not just at a uniformly distributed pattern of points, as in the example shown, but rather along abutting corrugation crest lines, while the corrugation troughs lying opposite one another each define a heating layer channel.

Furthermore, it will be understood that instead of the sinusoidal corrugated structure shown, it is also possible to use corrugated profile plates of any other conventional corrugated structure. Furthermore as an alternative to the rectangular design it is possible to provide any other outer contour for the plate stack. Instead of the plate structure shown, it is alternatively also possible to use a different layered structure for the reactor according to the invention, for example in the form of radially alternating reforming layers and heating layers of a module composed of tubes fitted concentrically inside one another.

To maintain constant cross sections of flow of the individual layers, i.e. in particular the distance between in each case two pairs of corrugated profile plates, it is possible, as an alternative to the supporting webs 6 shown, for in each case two corrugated profile plates of each pair of corrugated profile plates to be fixed together, for example by welding or soldering, at the locations where they abut one another. As a further measure for stabilizing the layered structure, it is possible to design spacers, for example by integral moulding or stamping, on the reforming layer side of the corrugated profile plates, by means of which spacers the two mutually facing corrugated profile plates of adjacent pairs of corrugated profile plates are supported with respect to one another at corresponding points by means of their reforming layer sides. It will be understood that any desired combinations of the supporting and stabilizing measures listed are also possible.

If the heating layers are designed as a CO oxidation stage, the reformate gas emerging from the reforming outlet(s) is introduced into the heating inlets through a corresponding piping structure. Then, undesirable carbon monoxide is removed from the reformate gas in the heating layers by selective CO oxidation. The reformate gas from which CO has been removed in this way can then be used in particular to supply fuel cells, for example in a fuel cell vehicle.

Furthermore, it will be understood that the respective heating layer is not necessarily, as shown, defined by a pair of corrugated profile plates; rather, as an alternative, it may also be defined by two different plate elements, for example by two planar plate elements. In this case, these elements are at a shorter distance from one another than the two plate elements which in each case define a reforming layer, and may be provided with turbulence-forming elements on the heating layer side. Instead of turbulence-forming elements which are formed on the plate elements themselves, it is also possible for a turbulence insert to be introduced into the respective heating layer between the two plate elements.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A reforming reactor having a layered structure, comprising an alternating sequence of individual reforming layers filled with a reforming catalyst material for an endothermic reforming reaction, and heating layers which adjoin the reforming layer via a thermally conductive partition and contain a heating-space catalyst material for an exothermic reaction; wherein
volume of the reaction layers is greater than volume of the heating layers; and
heating-space catalyst material is introduced into the corresponding heating layer as a wall coating.

2. The reforming reactor according to claim 1, wherein the volume of the reforming layer volume is at least twice as great as the volume of the heating layer volume.

3. The reforming reactor according to claim 1, wherein the heating layers are designed as one of catalytic burners and CO oxidation stages for the selective oxidation of carbon monoxide which is contained in the reformate gas generated in the reforming layer.

4. The reforming reactor according to claim 1, wherein
the respective heating layers are formed by internal spaces between pairs of corrugated profile plates which bear against one another; and
adjacent pairs of corrugated profile plates are spaced apart from one another, leaving a gap which forms a respective reforming layer.

5. The reforming reactor according to claim 1, wherein supporting elements for supporting adjacent profile plates are introduced into the respective reforming layers.

6. The reforming reactor according to claim 1, wherein:
spacers are formed on a reforming layer side of profile plates;
the spacers support each two opposite partitions of a reforming layer with respect to one another.
